(19) United States
(12) Patent Application Publication
(10) Pub. No.: US 2010/0109929 A1
(43) Pub. Date: May 6, 2010

(54) COMMUNICATION AND REMOTE SENSING APPLICATIONS WITH SIGNALS CODED WITH PERFECT CODES

(76) Inventor: Markku Sakari Lehtinen, Sodankyla (FI)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/448,870

(22) PCT Filed: Jan. 11, 2008
(86) PCT No.: PCT/FI2008/000002

§ 371 Date: Nov. 23, 2009

(30) Foreign Application Priority Data
Jan. 12, 2007 (FI) 20070031

(51) Int. Cl. H04L 17/02

(52) U.S. Cl. 341/173

(57) ABSTRACT

A code for signal transmission is a so-called perfect code with zero sidelobes in its autocorrelation function if and only if the modulus of the Fourier transform of said code is equal to 1. A communication device equipped for communications with perfect codes is one, a code source of which outputs a perfect code. A remote sensing device equipped for remote sensing with perfect codes is one, a code source of which outputs a perfect code.

### TECHNICAL FIELD

The invention concerns generally the use of a coded electromagnetic signal for the purpose of conveying information between a transmitter and a receiver. In general the invention concerns the use of codes that are perfect in the sense that their autocorrelation functions are free of sidelobes.

### BACKGROUND OF THE INVENTION

There are many reasons for applying a code to an electromagnetic signal to be transmitted. FIG. 1 illustrates a communications application, in which a transmitter 101 generates a time-discrete signal S=s(t) to be transmitted to the receiver 111. The transmission will take place through a wireless channel, where effects like interference, fading and multipath propagation will cause distortions. Additionally it may be desirable to keep unauthorised third parties from receiving the signal. In order to compensate for distorting effects and/or to make unauthorised reception difficult, an encoding unit 102 of the transmitter 101 employs a code C to produce an encoded signal C(S). A decoding unit 112 of the receiver employs an inverse code C⁻¹ to cancel the effect of coding, so that as a result the original signal S is produced. In many cases of digital coding the inverse is the same as the original code, i.e. C⁻¹=C, or a time inverse of the original code, i.e. C⁻¹(t)=C(−t).

FIG. 2 illustrates a remote sensing application, in which the purpose is to detect some features of a target 221 by using a transmitter 201 to transmit electromagnetic radiation towards the target 221 and a receiver 211 to receive a reflection from the target 221. For example in many radar applications the target 221 is actually a distribution of reflectivity values at different distances. Range resolution could be enhanced by only transmitting a very short radar pulse and by observing the arrival of echoes from different distances. This would lead to uneconomical use of the radar duty cycle and decrease the mean received power. A better solution is to use a coding filter 202 in the transmitter and a corresponding decoding filter 212 in the receiver to apply a phase-modulated pulse code to the transmitted radar signal and to derive the distribution of reflectivity values as a function of distance by convolving the received signal with the impulse response of a suitable reception filter.

From the viewpoint of signal generation there are significant differences between communication and remote sensing applications. In communications, the contents of the original signal to be transmitted cannot be predicted beforehand: the original payload signal resembles more a random bit stream. The coded transmission signal is produced as a convolution of said bit stream with the code. Although in remote sensing applications a similar approach is possible, in which the original signal to be transmitted is thought to consist of an elementary pulse (or a sequence of elementary pulses) and the coded transmission signal is produced by convolving the elementary pulse(s) with the code, it is more common not to think about elementary pulses and coding filters separately but to take the coded transmission signal as such, as a given, unitary entity.

An important similarity in communication and remote sensing applications is the reliance on the orthogonal properties of the code. In communications, random noise and transmissions coded with different codes will not correlate with the coded form of the transmission signal, so the inverse coding operation at the receiver will cause them to cancel out. In range-specific remote sensing, when a particular distance is considered, reflections of the same coded transmission signal from different distances will similarly cancel out due to code orthogonality, if the time difference between them is sufficiently long in the received composite signal.

The goodness of a code for purposes like those illustrated above is measured by its autocorrelation properties. As an example, let us consider the so-called Barker codes originally introduced in Barker, R. H.: “Group Synchronizing of Binary Digital Systems”, in: Communications Theory, edited by Jackson, W. Academic Press, New York, 273-287, 1953. Known Barker codes are finite bit sequences that have been shown to be the most efficient binary codes using single code sequences. The autocorrelation function of each Barker code has a central peak and a number of sidelobes on each side of it. The peak-to-sidelobe ratio equals the length of the Barker code in bits.

The use of a matched filter is a known technique for receiving coded transmissions. A matched filter is one that maximises the output signal-to-noise ratio in the presence of additive stochastic noise. The matched filter that corresponds to a known binary code has an impulse response that is a time-reversed and conjugated version of the transmitted coded signal. In digital signal processing the use of a matched filter has the advantages that the filter has a finite length and filtering is readily implemented with a number of logical operations; on the other hand the effect of sidelobes in the autocorrelation function just has to be accepted.

A technique known as mismatched filtering has been described in publications like Luke, H. D.: “Mismatched filtering of periodic quadriphase and 8-phase sequences”, IEEE Transactions on Communications, Vol. 51, No. 7, July 2003, and Damtie, B., Lehtinen, M., Orispää, M., Vierinen, J.: “Mismatched filtering of aperiodic quadriphase codes”, IEEE Transactions on Aerospace and Electronic Systems, Vol. XX, No. Y, submitted in August 2006. The convolution of the impulse response of the mismatched filter with the transmission code produces a weight function with no sidelobes. A mismatched filter can be calculated for practically any code, with the merely theoretical exception that the Fourier transform of the code must not have any zeroes. Another merely theoretical drawback of mismatched filters is that the impulse response of a properly calculated mismatched filter has an infinite number of nonzero elements. This is not serious in practice, because only a finite number of elements in an “active range” of the impulse response will be large enough to have significance; the others are negligible and can be approximated with neutral values (zeroes). A yet another drawback of mismatched filters is that they do not achieve the optimal signal-to-noise ratio (SNR) of matched filters. The effect of this drawback can be minimised by examining a large number of possible codes and their corresponding mismatched filters, and selecting those associated with the smallest penalty in SNR (see the last-mentioned prior art publication).

Despite of the many advantages of mismatched filtering, there remains the ultimate aim of presenting perfect codes, the autocorrelation functions of which would exhibit zero sidelobes.

### SUMMARY OF THE INVENTION

An objective of the present invention is to present codes for digital signal processing that would have arbitrarily small sidelobes in their autocorrelation functions. Another objective of the invention is to present devices for communication and remote sensing that are capable of utilising such codes.

The objectives of the invention are achieved by employing codes that can be derived from near-perfect codes by applying a certain calculational criterion.

An electronic device for outputting a code according to the invention is characterised in that it is configured to output a finite sequence of elements, which finite sequence of elements constitutes a code that with a predefined numerical accuracy is equal to an infinite sequence of elements that has the characteristic that the modulus of the Fourier transform of said infinite sequence of elements is equal to 1.

A communication device adapted to implement coded communications with at least one other communication device according to the invention is characterized in that it comprises:
at least one of a transmitter and a receiver, and
a code source configured to provide said at least one of a transmitter and a receiver with a finite sequence of elements, which finite sequence of elements constitutes a code that with a predefined numerical accuracy is equal to an infinite sequence of elements that has the characteristic that the modulus of the Fourier transform of said infinite sequence of elements is equal to 1.

A remote sensing device adapted to transmit a coded transmission signal towards a target according to the invention comprises:
a transmitter, and
a transmission signal source configured to provide said transmitter with a finite sequence of elements, which finite sequence of elements constitutes a code that with a predefined numerical accuracy is equal to an infinite sequence of elements that has the characteristic that the modulus of the Fourier transform of said infinite sequence of elements is equal to 1.

A method for transmitting an encoded signal, a method for receiving a decoding an encoded signal, and a method for remotely sensing a target according to the invention are all characterised by using as the code a finite sequence of elements, which finite sequence of elements constitutes a code that with a predefined numerical accuracy is equal to an infinite sequence of elements that has the characteristic that the modulus of the Fourier transform of said infinite sequence of elements is equal to 1.

A method for producing a code according to the invention is characterized in that the method comprises producing a finite sequence of elements, which finite sequence of elements constitutes a code that with a predefined numerical accuracy is equal to an infinite sequence of elements that has the characteristic that the modulus of the Fourier transform of said infinite sequence of elements is equal to 1.

A computer program product according to the invention is characterized in that it comprises machine-readable instructions which, when executed on a computer, cause the computer to produce a finite sequence of elements, which finite sequence of elements constitutes a code that with a predefined numerical accuracy is equal to an infinite sequence of elements that has the characteristic that the modulus of the Fourier transform of said infinite sequence of elements is equal to 1.

Mismatched filters, with their capacity of completely eliminating the sidelobes of the weight function, were found by loosening some theoretical constraints; for example the theoretical drawback of the infinite length of the impulse response is accepted, because it can be shown to have no practical significance. In the present invention it was found that by allowing some similar degrees of freedom, it is indeed possible to derive codes that have no sidelobes in their autocorrelation function (or the sidelobes of which may be made arbitrarily small). The perfect codes too have the theoretical drawback of infinite length, but again it can be shown that only a relatively small number of elements in the code will differ enough from zero to give them practical significance.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF DRAWINGS

FIG. 1 illustrates a known application of coding in communications,

FIG. 2 illustrates a known application of coding in remote sensing,

FIG. 3a illustrates element values of a 13-bit Barker code,

FIG. 3b illustrates element values of a so-called perfect code,

FIG. 3c illustrates an autocorrelation function of the code of FIG. 3a,

FIG. 3d illustrates an autocorrelation function of the code of FIG. 3b,

FIG. 4 illustrates a programmable code source,

FIG. 5 illustrates a communication device utilising perfect codes,

FIG. 6 illustrates a remote sensing device utilising perfect codes,

FIG. 7 illustrates producing a perfect code according to an embodiment of the invention, and

FIG. 8 illustrates producing a perfect code according to another embodiment of the invention.

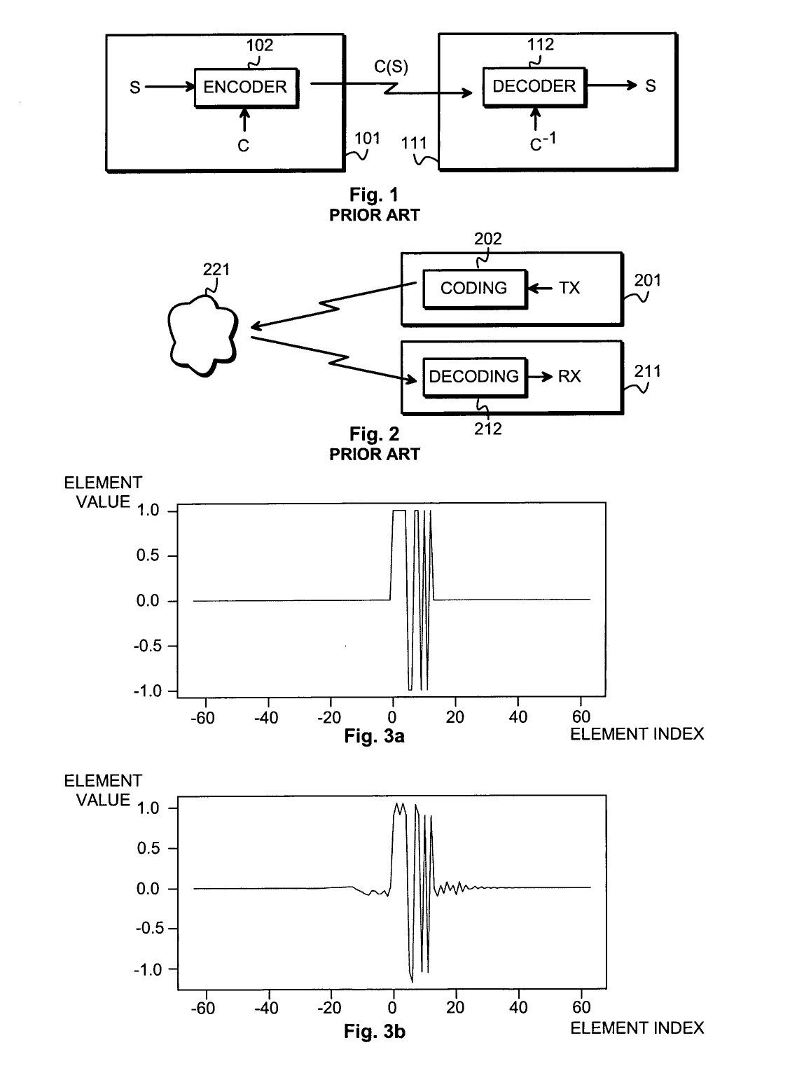

### DETAILED DESCRIPTION OF THE INVENTION AND EMBODIMENTS

Let us examine a sequence ε(n), n=1, 2, 3, . . . , N. Each element ε(n) has a phase and an amplitude. If the sequence represents an ordinary binary phase code, the amplitude of each element is constant (equal to 1) and the possible phase values are 0 and it radians. In the case of an ordinary quadriphase code the amplitudes are again constant but the allowable phase values are 0, π/2, π, and 3π/2 radians. These are only examples: at this stage we do not need to set any conditions to the phase and amplitude values of the elements in the sequence. Also, even if above we have assumed that the sequence is finite and has only N elements, we may also think about the sequence as having infinitely many elements (nε[−∞, ∞]), of which we know that at least those outside the range n=1, 2, 3, . . . , N are all zeroes.

The discrete Fourier transform \tilde{ε}(ω) of the sequence ε(n) is

$$\tilde{ɛ} ( ω ) = {\sum }_{n = - ∞}^{∞} ɛ ( n ) {e}^{- i n ω} , ω ∈ [ 0.2 π ) , \qquad ( 1 )$$

and the original sequence ε(n) can be written as the inverse transform of its Fourier transform \tilde{ε}(ω) as

$$ɛ ( n ) = \frac{1}{2 π} {\int }_{0}^{2 π} ɛ ( ω ) {e}^{i n ω} d ω . \qquad ( 2 )$$

If the sequence ε(n) represents the transmission code, it is conventional to define that its matched filter is the one, the impulse response hₘ(n) of which is equal to a time-inverted and conjugated copy of the code itself, i.e.

hₘ(n)= ε̅(̅−̅n̅)̅. (3)

Assuming that a coded transmission sequence ε(n) was transmitted and the matched filter hₘ(n) was used in reception, the time series observed at the receiver is the same as would be the response to a single uncoded pulse convolved with the range ambiguity function wₘ(n):

wₘ(n)=ε(n)*hₘ(n)=ε(n)* ε̅(̅−̅n̅)̅. (4)

Here the asterisk * means convolution. Using a matched filter leads to wₘ(n) having a central peak of height N and a set of sidelobes on both sides. If the sequence ε(n) was a Barker code, the height of the sidelobes is equal to 1.

The known mismatched filter for the sequence ε(n) is the one, the Fourier trans-form of which is equal to N/\tilde{ε}(ω). Using the inverse Fourier transform representation we may write the impulse response λ(n) of the mismatched filter as

$$λ ( n ) = \frac{1}{2 π} {\int }_{0}^{2 π} \frac{N}{\tilde{ɛ} ( ω )} {e}^{i n ω} d ω . \qquad ( 5 )$$

The theoretical drawbacks and their practical remedies concerning mismatched filters were discussed briefly earlier in the description of prior art.

The features of matched and mismatched filters that were recapitulated above are all known as such. In order to understand certain features of the present invention, let us first write the autocorrelation function a_{ε}(n) of a matched filter and the autocorrelation function a_{λ}(n) of a mismatched filter as follows:

$$\begin{matrix}{a}_{ɛ} ( n ) = {\sum }_{m} \overline{ɛ ( m )} ɛ ( m + n ) & ( 6 ) \\ {a}_{λ} ( n ) = {\sum }_{m} \overline{λ ( m )} λ ( m + n ) . & ( 7 )\end{matrix}$$

The convolution of these two autocorrelation functions is a single peak at the origin, as can be checked by the following calculation:

$$\begin{matrix}{\sum }_{k} {a}_{ɛ} ( k ) \overline{{a}_{λ} ( i - k )} = {\sum }_{k} {\sum }_{m} {\sum }_{{m}^{′}} \overline{ɛ ( m )} ɛ ( m + k ) λ ( {m}^{′} ) \overline{λ ( {m}^{′} + i - k )} \\ = {\sum }_{m} {\sum }_{{m}^{′}} \overline{ɛ ( m )} λ ( {m}^{′} ) δ ( m - {m}^{′} - i ) \\ = {\sum }_{m} ɛ \overline{( m )} λ ( m - i ) \\ = {N}_{b} δ ( i ) .\end{matrix} \qquad ( 8 )$$

Here N_{b} is the height of the central peak, and equals the number of elements in the original sequence ε(n) for sequences with pulses of unit amplitude. If the amplitudes of the pulses of the original sequence do not equal 1, N_{b} denotes the total energy of the sequence:

$${N}_{b} = {\sum }_{m} {\vert ɛ ( m ) \vert}^{2} .$$

The shown relation between said two autocorrelation functions means that—at least if the sidelobes of the autocorrelation functions are small compared to the main peak—the sidelobes associated with the mismatched filter are approximately equal to the negated sidelobes of the matched filter:

a_{λ}(n)≈−a_{ε}(n), when n≠0. (9)

Let us now designate as ε₁(n) the average of the original sequence ε(n) and its inverted mismatched filter λ(n):

$${ɛ}_{1} ( n ) = \frac{1}{2} ( ɛ ( n ) + λ ( - n ) ) . \qquad ( 10 )$$

The autocorrelation function a_{ε}_{₁}(n) of the first-order averaged sequence ε₁(n) is given as

$${a}_{{ɛ}_{1}} ( n ) = \frac{1}{4} ( 2 ( ɛ ⋆ λ ) ( n ) + {a}_{ɛ} ( n ) + {a}_{λ} ( n ) ) . \qquad ( 11 )$$

Utilising formula (9) we see that the two last terms in the parentheses essentially cancel. This means that the sidelobes of a_{ε}_{₁}(n) are clearly lower than those of a_{ε}(n). Thus, ε₁(n) is a better code than ε(n) in the autocorrelation sense. On the other hand, ε₁(n) is just another code sequence, for which a mismatched filter with an impulse response λ₁(n) can be calculated using the known techniques. Then yet another code ε₂(n) can be defined, analogously with formula (10), as

$${ɛ}_{2} ( n ) = \frac{1}{2} ( {ɛ}_{1} ( n ) + {λ}_{1} ( - n ) ) , \qquad ( 12 )$$

and the process can be continued an arbitrary number of times, expressed iteratively as

$${ɛ}_{q + 1} ( n ) = \frac{1}{2} ( {ɛ}_{q} ( n ) + {λ}_{q} ( - n ) ) , \\ q = 1 , 2 , 3 , … , \qquad ( 13 )$$

with the sidelobes of the autocorrelation function getting lower at every iteration step.

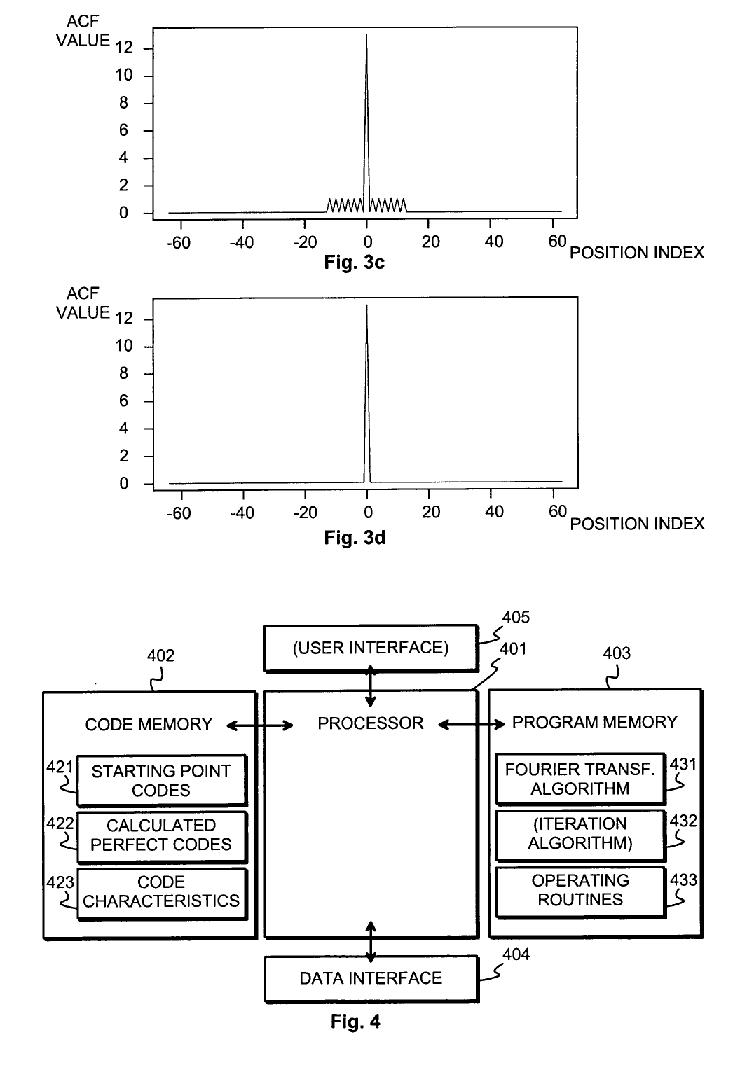

FIG. 3a illustrates a sequence ε(n), nε[−64, 64], where the elements ε(1) . . . ε(13) are the known elements of the 13-bit Barker code (1, 1, 1, 1, 1, −1, −1, 1, 1, −1, 1, −1, 1) and the rest of the elements are zeroes. FIG. 3b illustrates a sequence ε_{q}(n), nε[−64, 64], which has been produced by starting from sequence ε(n) and executing so many iteration rounds of the kind illustrated above in formula (13) that the difference between ε_{q+1}(n) and ε_{q}(n) becomes smaller than the numerical accuracy of the calculating device used. It is easy to see that many of the element values in sequence ε_{q}(n) are not exactly 1, −1 or 0, but have realnumbered values that differ by 0.10-0.15 at most from said integer values. With index values less than about −30 or greater than +40 the elements of the sequence ε_{q}(n) appear in the graphical representation to be essentially zeroes.

If we print out the elements of the sequence ε_{q}(n) with a numerical accuracy of five decimals, we note that with this accuracy there are non-zero elements only in the range of index values from −57 and +71; see the following table.

TABLE 1
selected elements of ε_{q}(n) derived
from 13-bit Barker code

| n | ε_{q}(n) |
|---|---|
| −60 | 0.00000 |
| −59 | 0.00000 |
| −58 | 0.00000 |
| −57 | 0.00001 |
| −56 | 0.00001 |
| −55 | 0.00001 |
| −54 | 0.00001 |
| −53 | 0.00001 |
| −52 | 0.00001 |
| −51 | 0.00001 |
| −50 | −0.00000 |
| −49 | −0.00001 |
| −48 | −0.00003 |
| −47 | −0.00005 |
| −46 | −0.00006 |
| −45 | −0.00007 |
| −44 | −0.00007 |
| −43 | −0.00006 |
| −42 | −0.00005 |
| −41 | −0.00002 |
| −40 | 0.00003 |
| −39 | 0.00009 |
| −38 | 0.00017 |
| −37 | 0.00029 |
| −36 | 0.00036 |
| −35 | 0.00042 |
| −34 | 0.00041 |
| −33 | 0.00034 |
| −32 | 0.00013 |
| −31 | −0.00010 |
| −30 | −0.00030 |
| −29 | −0.00068 |
| −28 | −0.00105 |
| −27 | −0.00152 |
| −26 | −0.00192 |
| −25 | −0.00276 |
| −24 | −0.00270 |
| −23 | −0.00184 |
| −22 | −0.00067 |
| −21 | 0.00129 |
| −20 | 0.00415 |
| −19 | 0.00658 |
| −18 | 0.00622 |
| −17 | 0.00855 |
| −16 | 0.01093 |
| −15 | 0.01262 |
| −14 | 0.01276 |
| −13 | 0.01874 |
| −12 | 0.01168 |
| −11 | −0.01654 |
| −10 | −0.03295 |
| −9 | −0.05212 |
| −8 | −0.07717 |
| −7 | −0.08756 |
| −6 | −0.03367 |
| −5 | −0.03566 |
| −4 | −0.07647 |
| −3 | −0.07061 |
| −2 | −0.03156 |
| −1 | −0.10521 |
| 0 | 0.01375 |
| 1 | 0.90179 |
| 2 | 1.05632 |
| 3 | 0.90711 |
| 4 | 1.05241 |
| 5 | 0.90814 |
| 6 | −1.03877 |
| 7 | −1.17682 |
| 8 | 1.03877 |
| 9 | 0.90814 |
| 10 | −1.05241 |
| 11 | 0.90711 |
| 12 | −1.05632 |
| 13 | 0.90179 |
| 14 | −0.01375 |
| 15 | −0.10521 |
| 16 | 0.03156 |
| 17 | −0.07061 |
| 18 | 0.07647 |
| 19 | −0.03566 |
| 20 | 0.03367 |
| 21 | −0.08756 |
| 22 | 0.07717 |
| 23 | −0.05212 |
| 24 | 0.03295 |
| 25 | −0.01654 |
| 26 | −0.01168 |
| 27 | 0.01874 |
| 28 | −0.01276 |
| 29 | 0.01262 |
| 30 | −0.01093 |
| 31 | 0.00855 |
| 32 | −0.00622 |
| 33 | 0.00658 |
| 34 | −0.00415 |
| 35 | 0.00129 |
| 36 | 0.00067 |
| 37 | −0.00184 |
| 38 | 0.00270 |
| 39 | −0.00276 |
| 40 | 0.00192 |
| 41 | −0.00152 |
| 42 | 0.00105 |
| 43 | −0.00068 |
| 44 | 0.00030 |
| 45 | −0.00010 |
| 46 | −0.00013 |
| 47 | 0.00034 |
| 48 | −0.00041 |
| 49 | 0.00042 |
| 50 | −0.00036 |
| 51 | 0.00029 |
| 52 | −0.00017 |
| 53 | 0.00009 |
| 54 | −0.00003 |
| 55 | −0.00002 |
| 56 | 0.00005 |
| 57 | −0.00006 |
| 58 | 0.00007 |
| 59 | −0.00007 |
| 60 | 0.00006 |
| 61 | −0.00005 |
| 62 | 0.00003 |
| 63 | −0.00001 |
| 64 | 0.00000 |
| 65 | 0.00001 |
| 66 | −0.00001 |
| 67 | 0.00001 |
| 68 | −0.00001 |
| 69 | 0.00001 |
| 70 | −0.00001 |
| 71 | 0.00001 |
| 72 | −0.00000 |
| 73 | 0.00000 |
| 74 | 0.00000 |
| 75 | 0.00000 |

The sequence ε_{q}(n) above is a representation of a so-called perfect code in the sense that its autocorrelation function has practically zero sidelobes. It is not unique: although starting from the above-mentioned sequence ε(n), where the elements ε(1) . . . ε(13) come from the 13-bit Barker code, causes the iteration to converge on these particular element values, something different would be arrived at if only we started from some other original sequence. As an example, we may consider the five-bit Barker code (1, 1, 1, −1, 1) as a starting point and arrive at the sequence illustrated in the following table.

TABLE 2
selected elements of ε_{q}(n) derived
from 5-bit Barker code

| n | ε_{q}(n) |
|---|---|
| −26 | 0.00000 |
| −25 | −0.00000 |
| −24 | −0.00001 |
| −23 | −0.00002 |
| −22 | −0.00001 |
| −21 | 0.00002 |
| −20 | 0.00006 |
| −19 | 0.00008 |
| −18 | 0.00001 |
| −17 | −0.00018 |
| −16 | −0.00032 |
| −15 | −0.00024 |
| −14 | 0.00025 |
| −13 | 0.00114 |
| −12 | 0.00146 |
| −11 | 0.00026 |
| −10 | −0.00259 |
| −9 | −0.00647 |
| −8 | −0.00560 |
| −7 | 0.00460 |
| −6 | 0.01926 |
| −5 | 0.03331 |
| −4 | 0.01504 |
| −3 | −0.06342 |
| −2 | −0.13103 |
| −1 | −0.16160 |
| 0 | 0.01781 |
| 1 | 0.86775 |
| 2 | 1.14257 |
| 3 | 0.88557 |
| 4 | −1.14257 |
| 5 | 0.86775 |
| 6 | −0.01781 |
| 7 | −0.16160 |
| 8 | 0.13103 |
| 9 | −0.06342 |
| 10 | −0.01504 |
| 11 | 0.03331 |
| 12 | −0.01926 |
| 13 | 0.00460 |
| 14 | 0.00560 |
| 15 | −0.00647 |
| 16 | 0.00259 |
| 17 | 0.00026 |
| 18 | −0.00146 |
| 19 | 0.00114 |
| 20 | −0.00025 |
| 21 | −0.00024 |
| 22 | 0.00032 |
| 23 | −0.00018 |
| 24 | −0.00001 |
| 25 | 0.00008 |
| 26 | −0.00006 |
| 27 | 0.00002 |
| 28 | 0.00001 |
| 29 | −0.00002 |
| 30 | 0.00001 |
| 31 | −0.00000 |
| 32 | −0.00000 |
| 33 | 0.00000 |

The iteration will converge if the original sequence already produced small enough sidelobes. Since Barker codes are known to have this property, they are good starting points, but also other kinds of sequences could be used to start the iteration.

FIG. 3c illustrates the autocorrelation function of the 13-bit Barker code, and FIG. 3d illustrates the autocorrelation function of the perfect code illustrated in FIG. 3b. Instead of iteration, a perfect code can be derived also directly. Let us define an operator Sₖ that causes a shift of k elements in a sequence:

(Sₖε)(n)=ε(n+k). (14)

Fourier-transforming a shifted sequence gives

$$\begin{matrix}{\sum }_{n = - ∞}^{∞} ( {S}_{k} ɛ ) ( n ) {e}^{- i n ω} = {\sum }_{n = - ∞}^{∞} ɛ ( n + k ) {e}^{- i n ω} \\ = {\sum }_{n = - ∞}^{∞} ɛ ( n ) {e}^{- i ( n - k ) ω} \\ = {e}^{i k ω} {\sum }_{n = - ∞}^{∞} ɛ ( n ) {e}^{- i n ω} \\ = {e}^{i k ω} \tilde{ɛ} ( ω )\end{matrix} \qquad ( 15 )$$

In order for a sequence εₚ(n) to represent a perfect code, the following condition must be true:

$${\sum }_{n} {ɛ}_{p} ( n ) \overline{( {S}_{k} {ɛ}_{p} ) ( n )} = \frac{1}{2 π} {\int }_{0}^{2 π} {e}^{i k ω} {\vert {\tilde{ɛ}}_{p} ( ω ) \vert}^{2} d ω = {δ}_{k , 0} . \qquad ( 16 )$$

Here we have utilised the result of (15) and the known property of Fourier trans-forms that inner products of l²-sequences (lowercase-L squared) are transformed to inner products of complex-valued L²-functions defined on [0, 2π). Equation (16) is true if and only if ═\tilde{ε}(ω)|=1 for almost all ω, because the only sequence with a constant 1 Fourier transform is known to be the simple sequence δ_{k,0}.

Let us now suppose that we have a sequence ε(n) that represents a close-to-perfect code. The expression “close-to-perfect” means that if we use ε(n) to substitute for εₚ(n) in formula (16), the equality is only approximately true, i.e. in addition to the delta spike at the origin there are certain other non-zero values, but they are small compared to the height of the delta spike. The norm, or modulus of the Fourier transform of the close-to-perfect code is |\tilde{ε}(ω)|≠1 and we can define a perfect code εₚ(n) by

$${ɛ}_{p} ( n ) = \frac{1}{2 π} {\int }_{0}^{2 π} {e}^{i n ω} \frac{\tilde{ɛ} ( ω )}{\vert \tilde{ɛ} ( ω ) \vert} d ω . \qquad ( 17 )$$

Thus, as a starting point we may use any known binary or multiphase code with low sidelobes, such as a Barker code for example, and arrive at a practically perfect code by applying formula (17). The selection of the code to start from is not limited to Barker codes. For example, the codes offered as being most optimal for mismatched filtering in the previously mentioned scientific publication of Damtie et al. are good starting points. Depending on source, the scalar measure |\tilde{ε}(ω)| may be designated either as the “modulus” or the “norm” of the Fourier transform \tilde{ε}(ω); we use the designation “modulus” in this description.

If the length of the starting code ε(n) is finite, it's Fourier transform \tilde{ε}(ω) is infinitely differentiable, and so is \tilde{ε}(ω)/|\tilde{ε}(ω)|, because for close-to-perfect codes |\tilde{ε}(ω)|≠1 and the denominator cannot be zero in \tilde{ε}(ω)/|\tilde{ε}(ω)|. It follows from this, that while the sequence εₚ(n) that defines the perfect code is infinitely long, it's elements approach zero faster than any polynome and we only need to consider a finite number of elements necessary to satisfy any numerical accuracy we should aim at.

Strictly speaking a code would be a perfect code in the sense discussed in this description if and only if the modulus of its Fourier transform is exactly equal to one; in other words the absolute value of the Fourier transform is equal to 1 with almost all values of ω. Only an infinitely long code may fulfil this strict criterion. An infinitely long code (i.e. a sequence having infinitely many elements) is a theoretical concept and not viable for practical use. On the other hand it is important to note that also a vast majority of real numbers only exist in theory, and must be approximated with something more practical in real-life devices: a computer can only handle a grid of discrete numerical values spaced apart by an amount that equals the numerical accuracy that the computer has been programmed to use.

So theoretically the modulus of a Fourier transform can equal one only if the sequence from which the Fourier transform was calculated had infinitely many elements (or if the sequence is a trivial case with only one non-zero element). However, the existence of perfect codes in practice relies on the fact that there exist sequences, the “tails” of which (in both negative and positive directions) only consist of elements the values of which are so close to zero that it would be impossible (or at least impractical) to handle them as anything else than zeroes in the memory of a digital signal processing device. Thus, it is sufficient to only store that part of the sequence in the memory of said digital signal processing device that includes elements with values that differ enough from zero to have a practical representation. A theoretically calculated Fourier transform of (only) the infinitely long sequence would have a modulus equal to one, but in practice a numerically calculated Fourier transform of also the above-mentioned part of the sequence will have a modulus that is equal to one with the employed numerical accuracy.

A plaintext description of equation (17) above is that since with known close-to-perfect codes said modulus is only approximately 1, it is possible to derive a perfect code from a close-to-perfect code by dividing the Fourier transform of said close-to-perfect code with the modulus of said Fourier transform and taking the inverse Fourier transform of the result of such division.

A corollary of this thinking is that it is possible to generate perfect codes in general by only requiring that the modulus of a Fourier transform of a code is equal to 1; in other words, by selecting an arbitrary Fourier transform (which does not have to be the Fourier transform of any known close-to-perfect code) that happens to have the characteristic of its modulus being equal to 1 (with the required numerical accuracy), and taking its inverse transform. It is likely that such an inverse transform of just some arbitrarily selected Fourier-transform-type starting point would be quite extraordinary in shape and technically maybe not viable for use as a code. On the other hand, taken the infinitely large number of possible starting points, it is perfectly possible that also some very attractive and advantageous code sequences can be found this way.

Even if a known close-to-perfect code was selected as a starting point, it should not be considered mandatory that a perfect code could only be found by dividing the Fourier transform of such a starting point with its modulus. Dividing by modulus is only one way of selecting a modified function of modulus one that is close to but different from the original Fourier transform, and also other selections could be made. Intuitively this means that making good selections and inversely transforming them might lead to a variety of perfect codes, with some advantageous characteristics like e.g. the absolute amplitudes of all main pulses in the code being equal to a constant (and thus scalable to any convenient value, like 1) and only phases being more complicated.

FIG. 4 illustrates schematically a programmable code source according to an embodiment of the invention. The code source comprises a processor 401, a code memory 402, a program memory 403, a data interface 404 and optionally a user interface 405. Said elements do not need to be physically separate entities, but their existence has been separately illustrated in FIG. 4 for reasons of graphical clarity. The processor 401 is configured to execute programs stored in the program memory 403. The code memory 402 is configured to store starting point codes (for example Barker codes or other close-to-perfect codes) 421, calculated perfect codes 422 and optionally also code characteristics 423, which describe features of various codes and/or information like the applicability of different codes to different purposes or statistics about code usage. The program memory 403 is configured to store programs for calculating perfect codes from starting point codes. Shown in FIG. 4 are a Fourier transform based program 431 that implements formula (17) above, and an iteration based algorithm 432 that implements formula (13) above. Alternatively or additionally the program memory 403 might store other calculation programs that implement the generation of perfect codes in other ways; such alternative ways have been discussed in the two immediately preceding paragraphs above. The program memory 403 is also configured to store operating routines 433 that the processor 401 executes e.g. to respond to inputs from the user and data interfaces, to implement memory management, and the like.

The data interface 404 is the means for the processor 401 to communicate with other electronic devices, and the user interface 405 is the means for the processor 401 to exchange information with a human user. If the programmable code source has been implemented as a part of a larger computer arrangement, it can use the interfaces of that computer arrangement and does not need any of its own.

Using perfect codes for communication or remote sensing applications could naturally be accomplished also without the immediate presence of a programmable code source, for example so that a programmable code source has previously calculated a required number of perfect codes and stored them into a memory, from which a communication or remote sensing device can read them and take them into use according to need without e.g. having to know, from which starting point code some particular perfect code has been obtained and through which calculational process. Schematically, one could then consider the “Calculated Perfect Codes” part 422 as a kind of “read-only” type code source.

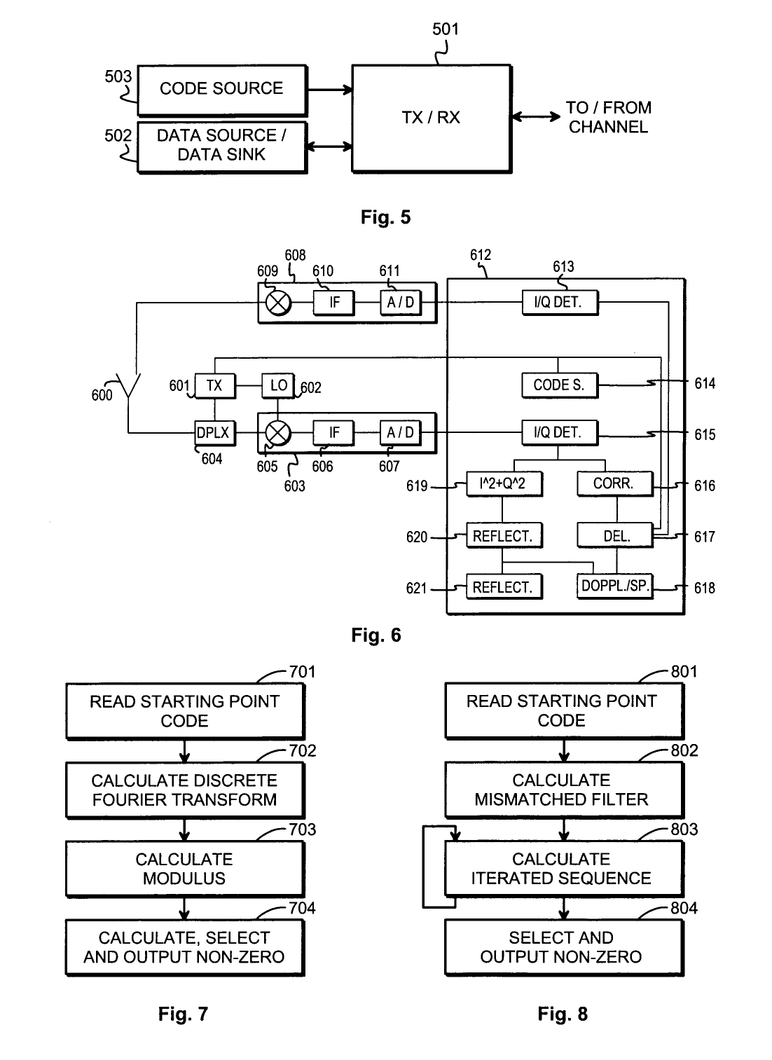

FIG. 5 illustrates schematically a bidirectional communications device according to an embodiment of the invention. A transceiver 501 is configured to transmit and receive digital encoded information over a transmission channel. Data to be encoded and transmitted comes from a data source included in block 502, and received and decoded data goes to a data sink in the same block. For encoding and decoding operations the transceiver 501 uses codes obtained from a code source 503, which may be for example a programmable code source of the kind illustrated in FIG. 4 or a read-only type code source. The transceiver 501 may be for example a transceiver of a cellular radio system that utilises spread spectrum technology for encoding transmissions over the wireless interface between base stations and mobile terminals, in which case it uses the codes read from the code source 503 as the pseudorandom sequence needed for spreading and despreading operations.

The invention does not require the communications device to be capable of bidirectional communications. For example in conventional broadcasting applications a broadcasting station may well be equipped for encoding and transmission only, and terminal stations may be equipped for reception and decoding only.

FIG. 6 shows a radar system, which is an example of a remote sensing system according to an embodiment of the invention. In this example, an antenna 600 functions as both transmission and reception antenna and the signal is directed from the transmitter 601 to the antenna or from the antenna to the receiver 603 by means of a duplexing switch 604. The receiver 603 comprises in a known manner an intermediate frequency (IF) mixer, IF amplifier 606 and an analog-to-digital converter 607. Mixing frequency comes to the IF mixer 605 and transmitter 601 from a local oscillator 602. In this exemplary radar set a transmitted pulse-coded signal is measured by a separate receiver 608 which is comprised of corresponding parts: an IF mixer 609, IF amplifier 610 and an analog-to-digital converter 611. Measuring transmitted signals is not necessary in many radar systems where the form and content of the transmitted signal can otherwise be known at the required accuracy.

In the exemplary apparatus the transmitter 601 is controlled and the received data are processed by a computer 612. The shape of the pulse-coded signal to be transmitted comes from a code source 614, which may be for example a programmable code source such as shown above in FIG. 4, or a read-only type code source. Signal detection is performed by means of software in an I/Q detection block 615. For the detection of measured transmission pulses the system shown in FIG. 6 has a separate detection block 613. Computation of reflectivity starts with the squaring of the signal in block 619 the result of which is processed so as to become unambiguous with respect to the range by solving in block 620 the equations representing the response of the measurement. The final radar reflectivity results are produced in block 621. When the reflectivity values for the various ranges have been calculated, the final results can be produced and stored and/or displayed to the user in a known manner. In the case of a weather radar, a typical end result is a pattern in which the reflectivity values are interpreted as meteorological phenomena (such as rain of different intensities) and presented graphically using color codes. The invention does not limit the way in which the final results are generated or presented.

Computation of delay values is a little more complicated. The cross products of the samples are computed in block 616 whereafter the equations depending on the range of the delays are solved in block 617. The coefficients of these equations depend on the contents of the transmitted encoded signal. Therefore, data representing the transmitted signal measured by receiver 608, and/or data representing the original form of the transmission code from the code source 614 are included in the solution of the equations in block 617. The final velocity and Doppler spectrum products are produced in block 618 which may also use the reflectivity data of block 620. As regards the generation and storing and/or presentation of the final results, refer to what was stated above in connection with the final results representing reflectivity.

The use of perfect codes according to an embodiment of the invention and the arithmetic blocks described above are preferably realized in the equipment shown in FIG. 6 in such a manner that the computer 612 comprises at least one program memory in which a stored program controls the operation of the computer 612 so that the method according to the invention is part of said program. Programming the matrix operations, computation of delayed products and other arithmetic operations described above into processes executable by a computer is familiar to a person skilled in the art. The computer 612 may comprise one or more processors to realize the method according to the invention and other tasks relating to the control of the operation of the transmitter 601 and receivers 603 and 608. Preferably the computer 612 also comprises means, which is known per se, for controlling the movement of the antenna 600; for simplicity, said means is not shown in FIG. 6. The system of FIG. 6 may be located in a fixed manner at a ground station or on a vehicle, such as airplane, or it may be realized so as to be portable.

FIGS. 7 and 8 are schematic illustrations of both a method aspect and a computer program product aspect that constitute embodiments of the present invention. FIG. 7 corresponds to producing a code by using the direct approach discussed above in association with formula (17). At step 701, a starting point code is read. Its discrete Fourier transform is calculated at step 702, and the modulus of the discrete Fourier transform is calculated at step 703. At step 704 formula (17) is applied to calculate a sequence εₚ(n), and its elements are investigated to identify that range of indexes n that includes elements, the values of which differ from zero with the predefined numerical accuracy that is used. Those elements will constitute the finite sequence of elements that is eventually output as the perfect code at step 704.

In FIG. 8 the starting point code is read at step 801. In the iteration, the starting point code constitutes the sequence of the 1:st order. The corresponding mismatched filter is produced at step 802 using formula (5). Step 803 represents the iteration, i.e. repeated application of formula (13) until a predetermined ending condition is fulfilled. One exemplary ending condition is the requirement that two sequences of consecutive order must differ from each other less than a certain limit; e.g. the sequences must be same with the predefined numerical accuracy. At step 804 the non-zero elements (with the predefined numerical accuracy) of the final sequence are output as the desired perfect code.

Mathematically, the sequences that are handled according to the calculational formulas mentioned above should be infinitely long, which is impossible to implement in a real-life computer. A sufficiently good approximation of infinite sequences can be made by making the calculations with sequences that are much longer than any known practical sequence needed to represent a perfect code. In the examples above the perfect codes have somewhat more or somewhat less than one hundred elements, so something like several hundreds or several thousands elements should be enough for the sequences used in calculations.

The embodiments of the invention discussed above are exemplary only and do not limit the invention. In particular, it is possible to make small changes to calculated perfect codes, for example in order to round some calculationally obtained values to closest practical values that can be expressed in a conveniently short number of bits or in order to achieve some other comparable objectives—as long as such small changes only cause very small changes to the autocorrelation function of a truly perfect code, the resulting practical code is still a perfect code in the sense of the present invention. There is typically a trade-off between using a convenient representation of a code and obtaining the best possible autocorrelation characteristics. How the trade-off decision is made depends on a variety of reasons, including but not being limited to the computing and storage capacity of the equipment that is used, and the resolution at which the element values of a code can be represented in an eventual signal to be transmitted. For example, if the element values of the code should be reflected in amplitude values of a signal to be transmitted, and the signal to be transmitted is generated in a D/A converter that operates with a certain quantization accuracy, it is not practical to calculate and store the values of the elements in the code with an accuracy that would be greater than what the D/A converted can implement in practice.

Similar trade-off considerations apply also to other changes that one could make to the element values or other characteristics of a perfect code. For example, changing the value of one of the five-decimal elements in Table 1 above by the amount of 0.00001 would cause only a very small change to the autocorrelation characteristics of the code. Changing it by 0.00002, or changing two element values each by 0.00001 would cause a slightly bigger change, and so on the more changes in element values, the bigger changes in autocorrelation, until at some point the autocorrelation function cannot be said to have zero sidelobes any more. However, all such “tampered” perfect codes are still perfect codes in the sense of this description, because making changes to the element values is essentially the same as just taking a coarser predetermined numerical accuracy.

The numerical accuracy that is considered does not need to be a power of ten or a power of two, but any convenient numerical accuracy can be used.

1. An electronic device for outputting a code, characterized in that the electronic device is configured to output a finite sequence of elements, which finite sequence of elements constitutes a code that with a predefined numerical accuracy is equal to an infinite sequence of elements that has the characteristic that the modulus of the Fourier transform of said infinite sequence of elements is equal to 1.

2. An electronic device according to claim 1, characterized in that as said finite sequence of elements it is configured to output a finite subset of an infinite sequence of at least one of the following kinds:
$${ɛ}_{p} ( n ) = \frac{1}{2 π} {\int }_{0}^{2 π} {e}^{i n ω} \frac{\tilde{ɛ} ( ω )}{\vert \tilde{ɛ} ( ω ) \vert} d ω or$$
$${ɛ}_{p + 1} ( n ) = \frac{1}{2} ( {ɛ}_{p} ( n ) + {λ}_{p} ( - n ) ) ,$$
where
εₚ (n) is the n:th element of a sequence of the p:th order,
εₚ₊₁(n) is the n:th element of a sequence of the (p+1):th order,
n is an integer,
p is a positive integer,
e is the neper base,
i is the imaginary unit,
ω is an integration variable,
\tilde{ε}(ω) is a discrete Fourier transform of a starting point code with low sidelobes in its autocorrelation function, and
λₚ(−n) is the (−n):th element of the impulse response of a mismatched filter corresponding to said sequence of the p:th order,
and where said finite subset comprises those elements of the infinite sequence that differ from zero with said predetermined numerical accuracy.

3. An electronic device according to claim 1, characterized in that it is a code source configured for use in a communication device that implements coded communications with other communication devices.

4. An electronic device according to claim 1, characterized in that it is a signal source configured for use in a remote sensing device that transmits a coded transmission signal towards a target.

5. A communication device adapted to implement coded communications with at least one other communication device, characterized in that it comprises:
at least one of a transmitter and a receiver configured to use a code to implement coded communications, and
a code source configured to provide said at least one of a transmitter and a receiver with a finite sequence of elements, which finite sequence of elements constitutes a code that with a predefined numerical accuracy is equal to an infinite sequence of elements that has the characteristic that the modulus of the Fourier transform of said infinite sequence of elements is equal to 1.

6. A communication device according to claim 5, characterized in that as said finite sequence of elements said code source is configured to provide said at least one of a transmitter and a receiver with a finite subset of an infinite sequence of at least one of the following kinds:
$${ɛ}_{p} ( n ) = \frac{1}{2 π} {\int }_{0}^{2 π} {e}^{i n ω} \frac{\tilde{ɛ} ( ω )}{\vert \tilde{ɛ} ( ω ) \vert} d ω or$$
$${ɛ}_{p + 1} ( n ) = \frac{1}{2} ( {ɛ}_{p} ( n ) + {λ}_{p} ( - n ) ) ,$$
where
εₚ(n) is the n:th element of a sequence of the p:th order,
εₚ₊₁(n) is the n:th element of a sequence of the (p+1):th order,
n is an integer,
p is a positive integer,
e is the neper base,
i is the imaginary unit,
ω is an integration variable,
\tilde{ε}(ω) is a discrete Fourier transform of a starting point code with low sidelobes in its autocorrelation function, and
λₚ(−n) is the (−n):th element of the impulse response of a mismatched filter corresponding to said sequence of the p:th order,
and where said finite subset comprises those elements of the infinite sequence that differ from zero with said predetermined numerical accuracy.

7. A remote sensing device adapted to transmit a coded transmission signal towards a target, characterized in that it comprises:
a transmitter, and
a transmission signal source configured to provide said transmitter with a finite sequence of elements, which finite sequence of elements constitutes a code that with a predefined numerical accuracy is equal to an infinite sequence of elements that has the characteristic that the modulus of the Fourier transform of said infinite sequence of elements is equal to 1;
wherein said transmitter is configured to use said code to transmit a coded trans-mission signal.

8. A remote sensing device according to claim 7, characterized in that as said finite sequence of elements said transmission signal source is configured to provide said transmitter with a finite subset of an infinite sequence of at least one of the following kinds:
$${ɛ}_{p} ( n ) = \frac{1}{2 π} {\int }_{0}^{2 π} {e}^{i n ω} \frac{\tilde{ɛ} ( ω )}{\vert \tilde{ɛ} ( ω ) \vert} d ω or$$
$${ɛ}_{p + 1} ( n ) = \frac{1}{2} ( {ɛ}_{p} ( n ) + {λ}_{p} ( - n ) ) ,$$
where
εₚ(n) is the n:th element of a sequence of the p:th order,
εₚ₊₁(n) is the n:th element of a sequence of the (p+1):th order,
n is an integer,
p is a positive integer,
e is the neper base,
i is the imaginary unit,
ω is an integration variable,
\tilde{ε}(ω) is a discrete Fourier transform of a starting point code with low sidelobes in its autocorrelation function, and
λₚ(−n) is the (−n):th element of the impulse response of a mismatched filter corresponding to said sequence of the p:th order,
and where said finite subset comprises those elements of the infinite sequence that differ from zero with said predetermined numerical accuracy.

9. A method for producing a code, characterized in that the method comprises producing a finite sequence of elements, which finite sequence of elements constitutes a code that with a predefined numerical accuracy is equal to an infinite sequence of elements that has the characteristic that the modulus of the Fourier transform of said infinite sequence of elements is equal to 1.

10. A method according to claim 9, characterized in that the method comprises:
producing a discrete Fourier transform of a starting point code,
producing a modulus of said discrete Fourier transform, and
producing said code as a finite subset of an infinite sequence of elements of the following kind:
$${ɛ}_{p} ( n ) = \frac{1}{2 π} {\int }_{0}^{2 π} {e}^{i n ω} \frac{\tilde{ɛ} ( ω )}{\vert \tilde{ɛ} ( ω ) \vert} d ω ,$$
where
εₚ(n) is the n:th element of a sequence of the p:th order,
n is an integer,
p is a positive integer,
e is the neper base,
i is the imaginary unit,
ω is an integration variable, and
\tilde{ε}(ω) is said discrete Fourier transform of a starting point code,
and where said finite subset comprises those elements of the infinite sequence that differ from zero with said predetermined numerical accuracy.

11. A method according to claim 9, characterized in that the method comprises:
producing a starting point code, and
producing said code as a finite subset of an infinite sequence of elements by performing a number of iterations of the following kind:
$${ɛ}_{p + 1} ( n ) = \frac{1}{2} ( {ɛ}_{p} ( n ) + {λ}_{p} ( - n ) ) ,$$
where
εₚ (n) is the n:th element of a sequence of the p:th order, and said starting point code constitutes the sequence of the 1:st order,
εₚ₊₁(n) is the n:th element of a sequence of the (p+1):th order,
n is an integer,
p is a positive integer, and
λₚ(−n) is the (−n):th element of the impulse response of a mismatched filter corresponding to said sequence of the p:th order,
and where said finite subset comprises those elements of the infinite sequence that differ from zero with said predetermined numerical accuracy.

12. A method for transmitting an encoded message, characterized in that it comprises:
representing a message to be transmitted in the form of a sequence of symbols,
encoding said sequence of symbols by convolving it with a finite sequence of elements, which finite sequence of elements constitutes a code that with a predefined numerical accuracy is equal to an infinite sequence of elements that has the characteristic that the modulus of the Fourier transform of said infinite sequence of elements is equal to 1, to produce an encoded message, and
transmitting said encoded message.

13. A method according to claim 12, characterized in that said convolving comprises convolving said sequence of symbols with a finite subset of an infinite sequence of elements of at least one of the following kinds:
$${ɛ}_{p} ( n ) = \frac{1}{2 π} {\int }_{0}^{2 π} {e}^{i n ω} \frac{\tilde{ɛ} ( ω )}{\vert \tilde{ɛ} ( ω ) \vert} d ω or$$
$${ɛ}_{p + 1} ( n ) = \frac{1}{2} ( {ɛ}_{p} ( n ) + {λ}_{p} ( - n ) ) ,$$
where
εₚ(n) is the n:th element of a sequence of the p:th order,
εₚ₊₁(n) is the n:th element of a sequence of the (p+1):th order,
n is an integer,
p is a positive integer,
e is the neper base,
i is the imaginary unit,
ω is an integration variable,
\tilde{ε}(ω) is a discrete Fourier transform of a starting point code with low sidelobes in its autocorrelation function, and
λₚ(−n) is the (−n):th element of the impulse response of a mismatched filter corresponding to said sequence of the p:th order,
and where said finite subset comprises those elements of the infinite sequence that differ from zero with said predetermined numerical accuracy.

14. A method for receiving and decoding an encoded message, characterized in that it comprises:
receiving an encoded message in the form of a sequence of encoded symbols,
decoding said sequence of encoded symbols by convolving it with a finite sequence of elements, which finite sequence of elements constitutes a code that with a predefined numerical accuracy is equal to an infinite sequence of elements that has the characteristic that the modulus of the Fourier transform of said infinite sequence of elements is equal to 1.

15. A method according to claim 14, characterized in that said convolving comprises convolving said sequence of encoded symbols with a finite subset of an infinite sequence of elements of at least one of the following kinds:
$${ɛ}_{p} ( n ) = \frac{1}{2 π} {\int }_{0}^{2 π} {e}^{i n ω} \frac{\tilde{ɛ} ( ω )}{\vert \tilde{ɛ} ( ω ) \vert} d ω or$$
$${ɛ}_{p + 1} ( n ) = \frac{1}{2} ( {ɛ}_{p} ( n ) + {λ}_{p} ( - n ) ) ,$$
where
εₚ(n) is the n:th element of a sequence of the p:th order,
εₚ₊₁(n) is the n:th element of a sequence of the (p+1):th order,
n is an integer,
p is a positive integer,
e is the neper base,
i is the imaginary unit,
ω is an integration variable,
\tilde{ε}(ω) is a discrete Fourier transform of a starting point code with low sidelobes in its autocorrelation function, and
λₚ(−n) is the (−n):th element of the impulse response of a mismatched filter corresponding to said sequence of the p:th order,
and where said finite subset comprises those elements of the infinite sequence that differ from zero with said predetermined numerical accuracy.

16. A method for remotely sensing a target, characterized in that it comprises transmitting a coded transmission signal towards a target, which coded transmission signal comprises a finite sequence of elements, which finite sequence of elements constitutes a code that with a predefined numerical accuracy is equal to an infinite sequence of elements that has the characteristic that the modulus of the Fourier transform of said infinite sequence of elements is equal to 1.

17. A method according to claim 16, characterized in that said finite sequence of elements is a finite subset of an infinite sequence of at least one of the following kinds:
$${ɛ}_{p} ( n ) = \frac{1}{2 π} {\int }_{0}^{2 π} {e}^{i n ω} \frac{\tilde{ɛ} ( ω )}{\vert \tilde{ɛ} ( ω ) \vert} d ω or$$
$${ɛ}_{p + 1} ( n ) = \frac{1}{2} ( {ɛ}_{p} ( n ) + {λ}_{p} ( - n ) ) ,$$
where
εₚ(n) is the n:th element of a sequence of the p:th order,
εₚ₊₁(n) is the n:th element of a sequence of the (p+1):th order,
n is an integer,
p is a positive integer,
e is the neper base,
i is the imaginary unit,
ω is an integration variable,
\tilde{ε}(ω) is a discrete Fourier transform of a starting point code with low sidelobes in its autocorrelation function, and
λₚ(−n) is the (−n):th element of the impulse response of a mismatched filter corresponding to said sequence of the p:th order,
and where said finite subset comprises those elements of the infinite sequence that differ from zero with said predetermined numerical accuracy.

18. A computer program product for producing a code, characterized in that the computer program product comprises machine-readable instructions which, when executed on a computer, cause the computer to produce a finite sequence of elements, which finite sequence of elements constitutes a code that with a predefined numerical accuracy is equal to an infinite sequence of elements that has the characteristic that the modulus of the Fourier transform of said infinite sequence of elements is equal to 1.
